(19) United States
(12) Patent Application Publication
(10) Pub. No.: US 2010/0261030 A1
(43) Pub. Date: Oct. 14, 2010

(54) METHOD FOR CREATING PATTERN ON A METAL SURFACE BY IMPRINTING WITH THE AID OF HEATING

(75) Inventor: RACHATA LEELAPRACHAKUL, BANGKOK (TH)

Correspondence Address: Pearne & Gordon LLP, 1801 East 9th Street, Suite 1200, Cleveland, OH, 44114-3108, US

(73) Assignee: INTER LICENSE CO., LTD., BANGKOK (TH)

(21) Appl. No.: 12/710,674

(22) Filed: Feb. 23, 2010

(30) Foreign Application Priority Data
Apr. 8, 2009 (TH) 0901001611

(51) Int. Cl. B32B 3/30; B21D 22/00

(52) U.S. Cl. 428/600; 72/352; 72/372

(57) ABSTRACT

This invention relates to the development of method for creating pattern on any metal surfaces used for structuring and decorative purposes by impression with the aid of heating. The method of the present invention can be modified to suite any industrial manufacturing processes.

### FIELD OF THE INVENTION

Imprinting technique, metal surface imprinting

### BACKGROUND OF THE INVENTION

This invention relates to the development of method for creating pattern on any metal surfaces used for structuring and decorative purposes by impression with the aid of heating. The method of the present invention can be modified to suite any industrial manufacturing processes.

Several shaped metal such as iron, both hot and cold rolled steel, are used for structural and decorating building. They come from several shapes such as L-beam, C-beam, square beam, round beam and patterned beam for decorating door and ceiling. At present there is no known technique for the creating a pattern on the surface of such metal work piece. The reason is such metal work pieces are designed for structural purpose, their thickness is too high for the impression technique and requires carving to creating a pattern on their surface.

The impression of patterns on the metal surface can be carried by any method known in the art. For example, a mold is impressed on the metal surface at room temperature which can create a 3 dimensional pattern having 0.1-2.0 mm depth which can feel by touching. Such technique, however, can not create a distinctive pattern and does not affect the hardness property of the work piece. In addition, the mold becomes wear quickly, resulting in short service life. If the metal work pieces is heated until its temperature is higher than 600° C., its surface will become soften. Pressing a mold at this elevated temperature can create a much sharpen and deeper pattern. This technique can be used to create patterns on the thick surface of alloy steels. The obtained pattern will be sharp and deep enough to modify the hardness property of the metal work piece. For the work piece to be used for structural construction, this technique can reduce the amount of the required metal. For example, creating a long bone-shape recess on the rod/beam used for structural construction as showed in FIG. 1a can strengthen the compressive strength of the work piece as near as the strength of a solid steel having thickness equals to the depth of the recess plus the original thickness of the work piece. Another example is the steel sheet used in constructing the wall of a water tank. This steel sheet must be always fabricated to have a concave surface to provide rigidity of the tank as showed in FIG. 1b.

The above mentioned applications are examples of metal work pieces modified to have increase strength apart from aesthetic purpose. The imprint on the metal surface may be artistic patterns, people, scenery etc. In addition the present printing technique can be used to produce decorating patterns on metal furniture such as edging of door, ceiling, rain drainage etc. In addition, the present printing technique is also more economical than the carving technique which consumes more time and expense.

### BRIEF DESCRIPTION OF THE DRAWINGS

FIG. 1 shows an example of a work piece of metal after being impressed to create a pattern having enough depth for strengthening 1a and 1b.

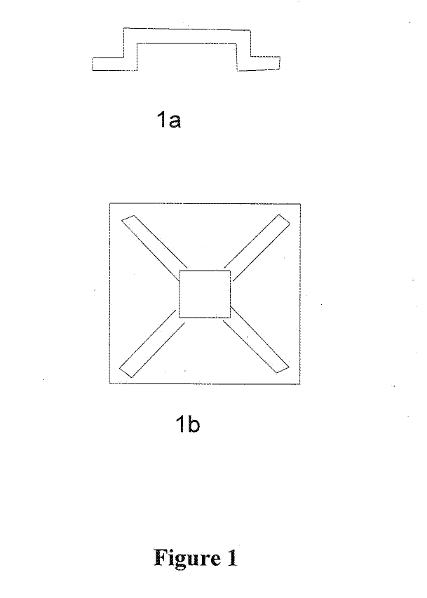

### DETAIL DESCRIPTION OF THE PREFERRED EMBODIMENTS

The method for creating patterns on a hot surface of a metal work piece of the present inventions comprises of steps of:

Washing oil and/or grease and any dirt on the surface of the metal work piece using any suitable solvents until the surface becomes clean. Next, heat the metal work piece using any suitable mean which can control the atmosphere around the metal surface. The metal surface is covered with an inert atmosphere while heating to prevent the reaction between the metal surface and gaseous oxygen. The supply of the inert gas must be suitably carried out by flowing an inert gas such as argon or nitrogen to replace the air on the metal surface. Since these inert gases are heavier than air, air can be replaced easily. Then, adjust the composition of the inert gas to a determined value. Finally, mix hydrogen to the gas mixture. An example of an appropriate, composition of the final gas mixture is 30% argon 30, 60% nitrogen and 7% hydrogen. Apart from using the above mentioned gas mixture, a single inert gas such as argon, nitrogen or helium can also be used but the effectiveness of the surface protection will less than using the gas mixture.

When the temperature of the work pieces is higher than 600° C., depending on the type of the metal, for example at a temperature between 1000-1300° C. for stainless steel, a double-side mold is pressed on the upper and lower surface of the work piece to create pattern on the upper and lower surface of the work piece. After the impression step, the temperature of the work piece is gradually decreased to provide uniform hardness on the metal surface. After the cool down step, the metal work piece is then machined to a determined shape such as L-beam, C-beam or decorating beam.

What is claimed is:

1. A method for creating pattern on a metal surface by impression and heating. The method comprises of steps of:
Clean the surface of the metal work piece.
Heating the metal work piece to a temperature higher than 600° C. under an inert gas atmosphere such as argon, nitrogen or helium and/or gas mixture between argon, nitrogen and hydrogen in the ratio 30:60:7, respectively.
Press the mold onto the surface of the metal work piece.
Gradually decreases the temperature of the metal work piece.
The unique characteristic of the present method is the impression of the mold onto the surface of the metal work piece at a temperature not lower than 600° C. under an inert gas atmosphere such as argon, nitrogen or helium and/or gas mixture between argon, nitrogen and hydrogen in the ration 30:60:7, respectively.

2. Shaped steel or a metal work piece having any patterns created by the method of claim 1.
